(19) United States
(12) Patent Application Publication
(10) Pub. No.: US 2025/0155539 A1
(43) Pub. Date: May 15, 2025

(54) RADIO WAVE MEASURING DEVICE AND RADIO WAVE MEASURING METHOD

(71) Applicant: NIPPON TELEGRAPH AND TELEPHONE CORPORATION, Tokyo (JP)

(72) Inventors: Masafumi YOSHIOKA, Musashino-shi, Tokyo (JP); Fumiaki NAGASE, Musashino-shi, Tokyo (JP); Keita KURIYAMA, Musashino-shi, Tokyo (JP); Toshifumi MIYAGI, Musashino-shi, Tokyo (JP)

(73) Assignee: NIPPON TELEGRAPH AND TELEPHONE CORPORATION, Tokyo (JP)

(21) Appl. No.: 18/837,227

(22) PCT Filed: Feb. 24, 2022
(86) PCT No.: PCT/JP2022/007686

§ 371 Date: Aug. 9, 2024

(51) Int. Cl. G01S 3/74

(52) U.S. Cl. CPC G01S 3/74

(57) ABSTRACT

A radio wave measurement device according to an embodiment includes a directional antenna that receives a radio wave, a reflecting plate whose direction of a reflecting surface that reflects radio waves is variable and that reflects radio waves toward the directional antenna, an angle meter that measures each angle of the reflecting plate in which a direction of the reflecting surface is sequentially changed, measurement circuitry configured to measure a received power or a C/N value of a radio wave reflected by the reflecting plate in which the direction of the reflecting surface is sequentially changed and received by the directional antenna, and output circuitry configured to output each angle measured by the angle meter and each of the received powers or the C/N values measured by the measurement circuitry in association with each other.

### TECHNICAL FIELD

The present invention relates to a radio wave measurement device and a radio wave measurement method.

### BACKGROUND ART

Many methods for estimating an arrival direction of radio waves in wireless communication have been proposed. For example, a beamforming method of estimating a direction in which a gain is indicated as being high as an arrival direction using an antenna having directivity is often used because of its simple configuration (see, for example, Non Patent Literature 1).

### CITATION LIST

### Non Patent Literature

Non Patent Literature 1: Minseok Kim, “Torai hoko suitei shisutemu no kiso to jissorei (in Japanese) (Basics and implementation examples of direction of arrival estimation system)”, Design Wave Magazine, 2007 December, pp. 112-118.

### SUMMARY OF INVENTION

### Technical Problem

However, when a radio wave used for wireless communication is in a low frequency band, an antenna is often large. It has been difficult to rotate a large antenna in a plurality of directions due to its weight, moment, and the like. That is, there is a problem that it is not easy to efficiently or accurately set the angle of the antenna.

The present invention has been made in view of the above-described problems, and an object of the present invention is to provide a radio wave measurement device and a radio wave measurement method capable of easily estimating an arrival direction of a radio wave even in a case where it is difficult to change a direction in which an antenna is directed.

### Solution to Problem

A radio wave measurement device according to an embodiment of the present invention includes a directional antenna that receives a radio wave, a reflecting plate whose direction of a reflecting surface that reflects radio waves is variable and that reflects radio waves toward the directional antenna, an angle meter that measures each angle of the reflecting plate in which a direction of the reflecting surface is sequentially changed, a measurement unit that measures a received power or a C/N value of a radio wave reflected by the reflecting plate in which the direction of the reflecting surface is sequentially changed and received by the directional antenna, and an output unit that outputs each angle measured by the angle meter and each of the received powers or the C/N values measured by the measurement unit in association with each other.

In addition, a radio wave measurement method according to an embodiment of the present invention includes measuring an angle of a reflecting plate by sequentially changing a direction of a reflecting surface of the reflecting plate that reflects a radio wave toward a directional antenna that receives the radio wave, measuring received power or a C/N value of a radio wave reflected by the reflecting plate whose direction of a reflecting surface is sequentially changed and received by the directional antenna, and outputting each measured angle and each measured received power or C/N value in association with each other.

### Advantageous Effects of Invention

According to the present invention, it is possible to easily estimate the arrival direction of the radio wave even when it is difficult to change the direction in which the antenna is directed.

### BRIEF DESCRIPTION OF DRAWINGS

FIG. 1 is a diagram illustrating a configuration example of a radio wave measurement device according to an embodiment.

FIG. 2(a) is a diagram illustrating an angle measured by an angle meter. FIG. 2(b) is a diagram illustrating a result of conversion by a conversion unit.

FIG. 3 is a diagram schematically illustrating an operation example of the radio wave measurement device in a case where a reflecting plate is oriented at an arbitrary azimuth angle and an arbitrary elevation angle.

FIG. 4 is a flowchart illustrating a method for enabling estimation of an arrival direction of a radio wave using the radio wave measurement device.

### DESCRIPTION OF EMBODIMENTS

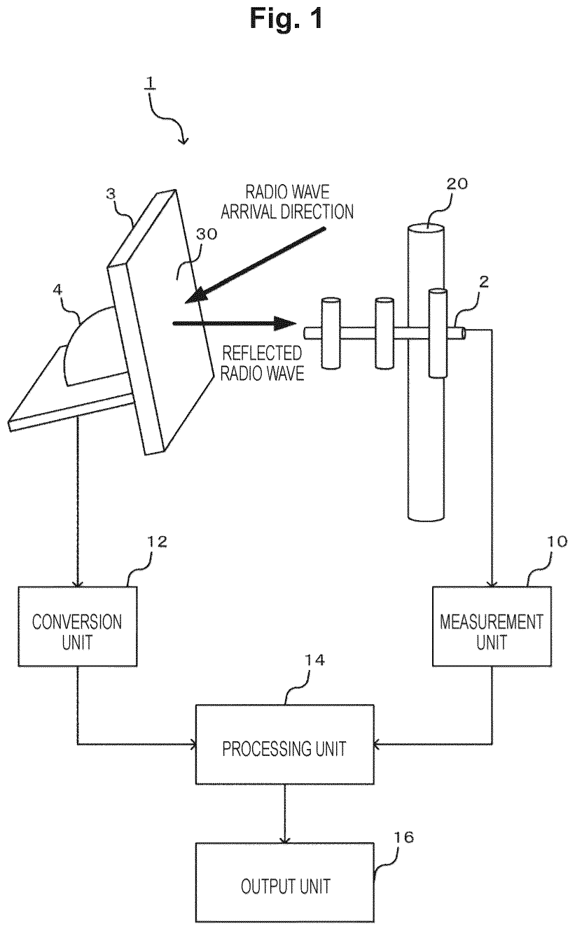

Hereinafter, a configuration example of a radio wave measurement device 1 according to an embodiment will be described with reference to the drawings. FIG. 1 is a diagram illustrating a configuration example of the radio wave measurement device 1 according to an embodiment.

As illustrated in FIG. 1, the radio wave measurement device 1 according to an embodiment includes a directional antenna 2, a reflecting plate 3, an angle meter 4, a measurement unit 10, a conversion unit 12, a processing unit 14, and an output unit 16.

The directional antenna 2 is directed, for example, in a direction in which a gain is lower than that when directed in another direction and is fixed to a fixing unit 20, receives a radio wave, and outputs received power to the measurement unit 10.

Further, the directional antenna 2 may be provided with a shielding portion (not illustrated) such as a radio wave absorber that shields radio waves from directions other than the facing direction to weaken the radio waves.

In the reflecting plate 3, the direction of the reflecting surface 30 that reflects the radio wave is made variable, and the radio wave is reflected toward the directional antenna 2. For example, the reflecting plate 3 reflects the radio wave by being made larger than the cross-sectional area of the first Fresnel zone based on the frequency of the radio wave received by the directional antenna 2 and the distance to the directional antenna 2.

The angle meter 4 measures each angle (for example, an azimuth angle and an elevation angle with respect to a reference direction) of the reflecting plate 3 in which the direction of the reflecting surface 30 is sequentially changed, and outputs the measured angle to the conversion unit 12.

The measurement unit 10 measures the received power or the C/N value of the radio wave reflected by the reflecting plate 3 in which the direction of the reflecting surface 30 is sequentially changed and received by the directional antenna 2, and outputs the measurement result to the processing unit 14.

The conversion unit 12 converts the angle measured by the angle meter 4 into the arrival direction of the radio wave received by the directional antenna 2, and outputs the converted result to the processing unit 14.

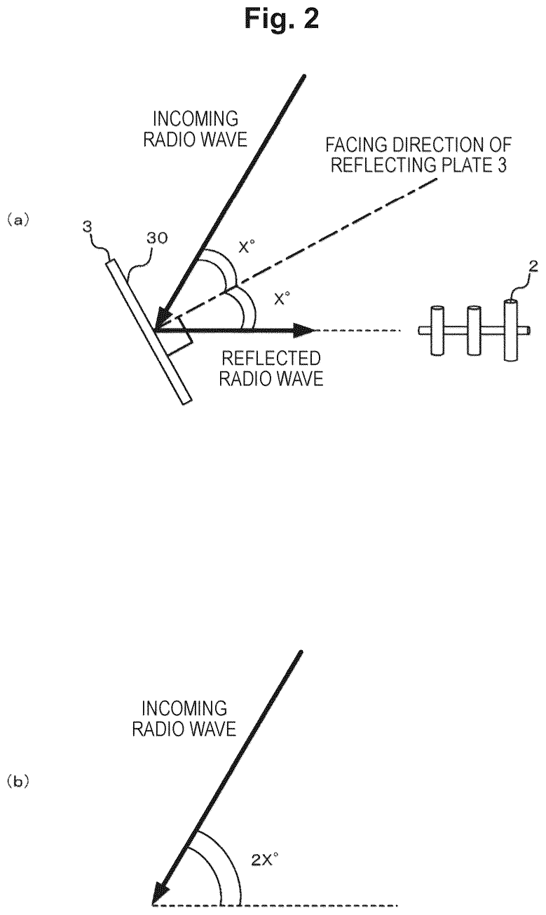

FIG. 2 is a diagram illustrating a result of conversion of the one-dimensional angle (−180° to +180°) measured by the angle meter 4 by the conversion unit 12. FIG. 2(a) is a diagram illustrating an angle (X°) measured by an angle meter 4. FIG. 2(b) is a diagram illustrating a result of conversion by a conversion unit 12.

As illustrated in FIG. 2(a), for example, it is assumed that the angle of the reflected wave reflected by the reflecting plate 3 toward the directional antenna 2 is X° with respect to the facing direction of the reflecting plate 3. At this time, the angle meter 4 measures the angle (X°) of the reflected wave reflected by the reflecting plate 3 toward the directional antenna 2. In addition, the incident angle of the incoming radio wave with respect to the reflecting plate 3 is also X°.

Then, as illustrated in FIG. 2(b), the conversion unit 12 converts the angle (X°) measured by the angle meter 4 into the arrival direction (2X°) of the radio wave received by the directional antenna 2, and outputs the converted result to the processing unit 14.

That is, in a case where the reflecting plate 3 is directed in the direction in which the received power of the directional antenna 2 that receives the radio wave from sufficiently far is maximized, if the angle measured by the angle meter 4 with respect to the facing direction of the reflecting plate 3 is X°, the angle before reflection (the angle indicating the arrival direction of the radio wave) is 2X°.

The processing unit 14 (FIG. 1) performs processing of associating the received power or the C/N value of the radio wave measured by the measurement unit 10 with the result converted by the conversion unit 12, and outputs the processing result to the output unit 16.

The output unit 16 outputs the result processed by the processing unit 14, for example, by displaying the result. That is, the output unit 16 outputs each angle measured by the angle meter 4 (result converted by the conversion unit 12) and each received power or C/N value measured by the measurement unit 10 in association with each other.

Therefore, the operator can easily estimate the arrival direction of the radio wave by referring to the result output from radio wave measurement device 1 even if it is difficult to change the direction in which directional antenna 2 is directed.

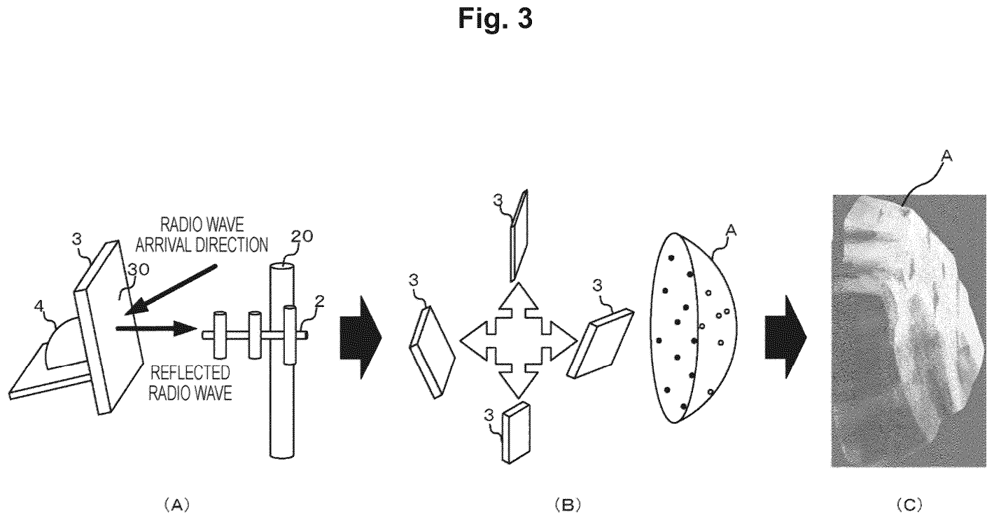

Next, a case where the reflecting plate 3 of the radio wave measurement device 1 is oriented at an arbitrary azimuth angle and an arbitrary elevation angle will be described. FIG. 3 is a diagram schematically illustrating an operation example of the radio wave measurement device 1 in a case where a reflecting plate 3 is oriented at an arbitrary azimuth angle and an arbitrary elevation angle.

For example, in the radio wave measurement device 1, the directional antenna 2 fixed to the fixing unit 20 receives the reflected radio wave reflected by the reflecting plate 3, and outputs the received power (state (A)). For example, the angle meter 4 measures the direction in which the reflecting plate 3 faces the directional antenna 2 with the deflection angle (Θ, ϕ) in the spherical coordinate system as (0, 0).

The radio wave measurement device 1 sequentially changes the direction of the reflecting plate 3 (state (B)). In a case where the reflecting plate 3 is installed in a direction in which the received power of the directional antenna 2 can be expected to be maximized, in a case where the angle meter 4 measures the deflection angle (Θ₁°, ϕ₁°) in the spherical coordinate system, the angle before reflection (the angle of the arrival direction of the radio wave) is (2Θ₁°, 2ϕ₁°).

In addition, the processing unit 14 performs curved surface approximation A by replacing each angle measured by the angle meter 4 (result of conversion by the conversion unit 12) with the radius of the hemisphere centered on the facing direction of the directional antenna 2, and associates each angle with each received power measured by the measurement unit 10.

Then, the output unit 16 displays, for example, an area having a radius of a predetermined value or more in white for the worker (state (C)).

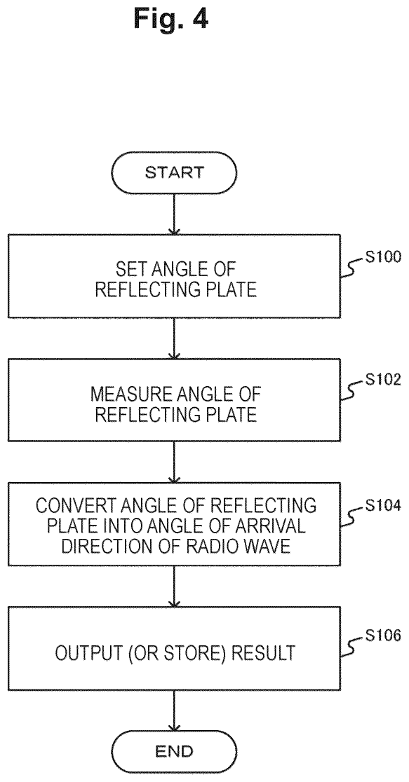

Next, a method for enabling estimation of an arrival direction of a radio wave using radio wave measurement device 1 will be described. FIG. 4 is a flowchart illustrating a method for enabling estimation of an arrival direction of the radio wave using the radio wave measurement device 1.

As illustrated in FIG. 4, in Step 100 (S100), the radio wave measurement device 1 sets the angle of the reflecting plate 3 according to the operation of the operator.

In Step 102 (S102), the angle meter 4 measures the angle of the reflecting plate 3 in a state where the reflecting plate 3 is reflecting and the directional antenna 2 is receiving a radio wave according to the operation of the operator.

In Step 104 (S104), the conversion unit 12 converts the angle of the reflecting plate 3 into the angle of the arrival direction of the radio wave.

In Step 106 (S106), the output unit 16 outputs the result processed by the processing unit 14 by display or the like. The radio wave measurement device 1 may output the result of the processing performed by the processing unit 14 after temporarily storing the result.

As described above, the radio wave measurement device 1 according to the embodiment can easily estimate the arrival direction of the radio wave even when it is difficult to change the direction in which the antenna is directed.

### REFERENCE SIGNS LIST

1 Radio wave measurement device
2 Directional antenna
3 Reflecting plate
4 Angle meter
10 Measurement unit
12 Conversion unit
14 Processing unit
16 Output unit
20 Fixing unit
30 Reflecting surface

1. A radio wave measurement device comprising:
a directional antenna that receives a radio wave;
a reflecting plate whose direction of a reflecting surface that reflects radio waves is variable and that reflects radio waves toward the directional antenna;
an angle meter that measures each angle of the reflecting plate in which a direction of the reflecting surface is sequentially changed;
measurement circuitry configured to measure a received power or a C/N value of a radio wave reflected by the reflecting plate in which the direction of the reflecting surface is sequentially changed and received by the directional antenna; and
output circuitry configured to output each angle measured by the angle meter and each of the received powers or the C/N values measured by the measurement circuitry in association with each other.

2. The radio wave measurement device according to claim 1, further comprising:
a shielding portion that shields the directional antenna to weaken a radio wave from a direction other than a facing direction.

3. The radio wave measurement device according to claim 1, wherein
the reflecting plate is
larger than a cross-sectional area of a first Fresnel zone based on a frequency of radio waves received by the directional antenna and a distance to the directional antenna.

4. The radio wave measurement device according to claim 1, wherein
the directional antenna is
fixed oriented in a direction where a gain is lower than a gain when the directional antenna is fixed oriented in other directions.

5. A radio wave measurement method comprising:
measuring an angle of a reflecting plate by sequentially changing a direction of a reflecting surface of the reflecting plate that reflects a radio wave toward a directional antenna that receives the radio wave;
measuring received power or a C/N value of a radio wave reflected by the reflecting plate whose direction of a reflecting surface is sequentially changed and received by the directional antenna; and
outputting each measured angle and each measured received power or C/N value in association with each other.

6. The radio wave measurement method according to claim 5, wherein
the directional antenna is provided with a shielding portion that shields radio waves from directions other than a facing direction so as to weaken the radio waves.

7. The radio wave measurement method according to claim 5, wherein
the reflecting plate is
larger than a cross-sectional area of a first Fresnel zone based on a frequency of radio waves received by the directional antenna and a distance to the directional antenna.

8. The radio wave measurement method according to claim 5, wherein
the directional antenna is
fixed oriented in a direction where a gain is lower than a gain when the directional antenna is fixed oriented in other directions.
